(19) United States
(12) Patent Application Publication
(10) Pub. No.: US 2016/0007128 A1
(43) Pub. Date: Jan. 7, 2016

(54) FITTING SYSTEM FOR A BIMODAL HEARING SYSTEM, CORRESPONDING METHOD AND HEARING SYSTEM

(71) Applicants: Hans-Ueli Roeck, Hombrechtikon (CH); Philipp Schneider, Zuerich (CH); Reto Kurmann, Staefa (CH); Lakshmi Mishra, Santa Clarita, CA (US); Guillermo A. Calle, Santa Clarita, CA (US); Christian Brunner, Jona (CH)

(72) Inventors: Hans-Ueli Roeck, Hombrechtikon (CH); Philipp Schneider, Zuerich (CH); Reto Kurmann, Staefa (CH); Lakshmi Mishra, Santa Clarita, CA (US); Guillermo A. Calle, Santa Clarita, CA (US); Christian Brunner, Jona (CH)

(73) Assignee: PHONAK AG, Staefa (CH)

(21) Appl. No.: 14/379,117

(22) PCT Filed: Feb. 29, 2012
(86) PCT No.: PCT/US2012/027090

§ 371 Date: Mar. 23, 2015

(51) Int. Cl. H04R 25/00

(52) U.S. Cl. CPC H04R 25/70; H04R 25/554; H04R 2225/67

(57) ABSTRACT

The present invention is related to a fitting system for a bimodal hearing system, a method for fitting such a hearing system and a corresponding bimodal hearing system. The fitting system is operationally connectable to a hearing instrument (HI) and to an implantable device (CI) and comprises a first fitting software module (FSWHI) for fitting the hearing instrument (HI). Thereby the fitting system further comprises a second fitting software module (FSWCI) for fitting the implantable device (CI) by considering data of the hearing instrument (HI) received from the first fitting software module (FSWHI) via a data interface (DI) and/or vice versa.

### TECHNICAL FIELD OF THE INVENTION

The present invention is related to a fitting system for a bimodal hearing system, a method for fitting such a hearing system and a corresponding bimodal hearing system.

### BACKGROUND OF THE INVENTION

A hearing system combining a hearing instrument on one side of the head and a cochlear implant (CI) on the other side of the head consisting of a speech processor in the combination with a headpiece and an implanted device, a so called bimodal hearing system, is well known for improving the perception of a hearing impaired user.

For example, DE 10 2008 060 056 A1 describes such a bimodal hearing system with a cochlear implant and a corresponding fitting system, called external device. The fitting system is used for fitting the hearing instrument, i.e. adapting the hearing instrument to user specific needs. The fitting is performed by connecting the hearing instrument and the cochlear implant to the fitting system and by executing a fitting software on the fitting system for fitting the hearing instrument according to information concerning the cochlear implant.

### SUMMARY OF THE INVENTION

The present invention has the objective to propose an improved fitting system for a bimodal hearing system, an improved method for fitting such a hearing system and a corresponding bimodal hearing system.

This objective is reached by a fitting system that comprises the features specified in claim 1. A method and a bimodal hearing system according to the invention as well as further embodiments of the invention are specified in the further claims.

Under the term “hearing instrument” a hearing device is understood, which is worn in or adjacent to the user's ear with the objective to improve the user's acoustical perception. In particular, a hearing instrument refers to:
a hearing aid for improving the perception of a hearing impaired user towards the hearing perception of a user with normal hearing ability,
a hearing protection for attenuating or barring acoustic signals from being perceived by the user, or
a communication device, in particular to be used by a user with normal hearing ability, for assisting the hearing perception under difficult acoustical circumstances, for example in a noisy environment.

With respect to any application area, a hearing device may be applied behind the ear, in the ear or completely in the ear canal.

Under an implantable device a hearing device is understood, which is at least partly implanted in the user with the objective to improve the acoustical perception of the user. In particular, a “cochlear implant” is an implantable device which is connected to the cochlea of the user, in particular via means for electrical or mechanical stimulation. For example, a speech processor (body worn or BTE or ITE), a head piece and an actual implanted part may together constitute the implantable device. Thus, the implantable device is understood in a broad generic meaning, whereas the “implanted part” or shortly “implant” is a specific part of the implantable device that is actually implanted in the user.

The term “fitting” embraces a user specific adaptation of the operational behavior of the hearing system, in particular of the hearing instrument and/or the implantable device. Thus, during the fitting process, the signal processing of the hearing system is adapted, for example by changing the configuration of its signal processing parameters. In one example, the fitting involves adjusting of filtering characteristics of the hearing system, in particular its filter coefficients.

Usually, the fitting is accomplished by an audiologist, also called a fitter, at the audiologist's office or at a service center for hearing systems. Thereby, the audiologist determines the user's hearing abilities by performing acoustic tests with diagnostic test equipment, interprets the results of the tests and adapts the signal processing of the hearing system accordingly. For this procedure, the audiologist typically uses a fitting system, which assists the audiologist to perform the fitting. Such a fitting system is able to execute a specific computer program, called fitting software. A specific module of this fitting software, a fitting software module, is designed for fitting a specific type of hearing device, for example the hearing instrument or the implantable device.

A “bimodal” hearing system refers to a hearing system, which comprises at least a combination of two different hearing devices, namely a hearing instrument that is used on one ear of the user and an implantable device that is used on the other ear of the user, in particular a cochlear implant. The hearing system may also comprise further devices such as a remote control.

The present invention involves a fitting system for a bimodal hearing system, wherein the fitting system is operationally connectable to a hearing instrument and to an implantable device and the fitting system comprises a first fitting software module for fitting the hearing instrument. Thereby the fitting system further comprises a second fitting software module for fitting the implantable device by considering data of the hearing instrument received from the first fitting software module via a data interface and vice versa. Thus, the operational behavior of the implantable device is coordinated to the fitting or operational behavior of the hearing instrument and/or vice versa.

This coordination refers to a mutual or unilateral coordination of the operational behavior, also called “synchronization”. This synchronization may or may not include a “time synchronization”, which is used to merely establish a physical time relation between two devices.

The invention is particular advantageous, because the operational behavior of an implantable device is significantly different from the operational behavior of a hearing instrument and therefore the consideration of the fitting of the hearing instrument provides a seamless overall behavior of the hearing system to the user and thus additional attractiveness, especially for the potential user of the implantable device.

In the hearing system according to the invention the implantable device is not regarded as the more relevant device, i.e. the implantable device is fitted in dependence of the hearing instrument or according to a mutual dependence with the hearing instrument. As not only audiometric data is relevant in the co-fitting, but others according to this invention as well, the dependence is often just the other way around from what is commonly done, namely to fit the hearing instrument in dependence of the implantable device.

Further, the fitting system according to the invention provides the following advantages:
The fitting of the implantable device and the hearing instrument can be accomplished together at the same location and/or during the same fitting session.
The fitting can be accomplished at different locations and/or during different fitting sessions and still be synchronized.
A compatible operational behavior of the different hearing devices, in particular consistent parameter settings, can be achieved.
The fitting of the bimodal hearing system, especially the hearing instrument and/or the implantable device, is not limited to activities in specialized clinics where the operation took place, but can also be performed in distributed acoustician's offices or service centers.
Features marginally connected to the fitting process, for example providing connectivity to cell phones, audio streaming from further devices such as MP3 players, can be coordinated between the hearing instrument and the implantable device.

Surprisingly, the fitting system according to the invention is particularly advantageous, because it efficiently combines different fitting procedures and takes advantage of the integral knowledge of each ear's physiology/hearing loss. This is based on the fact that the fitting of an implantable device is significantly different from the fitting of a hearing instrument, i.e. the fitting procedures are audiologically different with respect to workflow and/or fitting methods.

Also, independent of audiologically relevant fitting data, other configuration data such as number and type of hearing programs (parameter sets for a specific hearing situation), volume control range, availability of binaural features and other compatibility information, etc. can be exchanged in order to coordinate the behavior of the implantable device with the behavior of the hearing instrument.

Due to variations in placement of the electrodes during the implantation and physiological variations of the patients, no consistent physical model of the transfer function from the implantable device to the nerve firings exist. Thus, the fitting of the implantable device is highly based on subjective perception and no physical model of an amplification scheme exists.

Further, an implantable device such as a cochlear implant and the corresponding fitting software module is classified as medical class 3 product, which implies slow release cycles to fulfill the demands by regulatory bodies (FDA, TUV, etc.). On the other hand, the hearing instrument and the corresponding fitting software module is a medical class 2a product, which allows frequent launches of new software releases to the market, e.g. every six months or sooner.

Additionally, an implantable device requires an exact reproducibility of the fitting software module for a significantly longer time than for a hearing instrument. This makes the life time of a fitting software module for implantable device incompatible to the fast pace of the hearing instrument market.

In a further embodiment of the fitting system according to the invention, at least one of the first fitting software module and the second fitting software module is configured to at least one of transmit and receive the data as configuration data, in particular as fitting related data. In other words, the first fitting software module and/or the second fitting software module is configured to transmit and/or receive the transferred data as configuration data.

In a further embodiment of the fitting system according to the invention, the first fitting software module and the second fitting software module are configured for a mutual, in particular concurrent or common, coordination between the fitting of the implantable device and the fitting of the hearing instrument. This provides for a particular efficient fitting of the hearing system, because the time between fitting iterations is minimized. For example, complex adaptations of one or both of the hearing devices can be achieved within the same fitting session.

In a further embodiment of the fitting system according to the invention, the fitting system comprises a fourth software module for providing a common graphical user interface (GUI) for the first fitting software module and the second fitting software module. This way, common tasks such as client data handling or report generation is shared or at least graphically aligned, while the fitting procedures are kept separate.

In one example, the common graphical user interface is combined with network storage. This provides for particular efficient and/or comfortable user data management.

In a further embodiment of the fitting system according to the invention, the data interface is at least one of a standardized interface and an internal interface, in particular a COM or SOA interface. The standardized interface, also called formalized interface, defines the transferring of the data, in particular at least one of the type of interconnection, the format of the data to be transferred and the data protocol. Thus, each fitting software module can be exchanged or updated without affecting the other fitting software module. This is particularly advantageous in the case that the fitting software modules are produced by different vendors.

In one example, the local software interface is a COM interface (Component Object Model), i.e. a direct data exchange between both fitting software modules running concurrently on the same fitting system.

In another example, the data interface is based on service oriented architecture (SOA), wherein a data server provides services such as data access for the first and/or second fitting software module acting as client. The data server does not need to be physically present on the same computer as one or both of the first two fitting modules, but on any suitable server, connected over the intranet or internet, thereby potentially separating the two fitting modules physically as well as their concurrency in usage.

In a further example, the data interface is configured to use remote procedure calls (RPC) and in another further example, the data interface is configured to use a remote data connection such as an intranet or an internet connection.

In a further embodiment of the fitting system according to the invention, the data interface is configured to use a data connection, which directly, in particular wirelessly, connects the hearing instrument to the implantable device or to use an intermediate device, in particular a remote control or a mobile phone, which in this description and the claims is also called a smart phone. In this case the hearing instrument and/or the implantable device acts as a communication relay for a unidirectional or bidirectional transfer of data between fitting software modules.

Similarly, in case the data interface is configured to use an intermediate device, for example a remote control or a smart phone, this intermediate device also acts as communication relay. In addition, the intermediate device may also be configured by the first and/or second fitting software module.

In a further embodiment of the fitting system according to the invention, the data interface is connected to a memory unit, in particular a network storage unit, for, in particular intermittently, storing the data to be transferred. This way asynchronous access to the transferred data is provided as shared data over time and location.

In one example, the memory unit is located in at least one of the hearing instrument, the implantable device or an intermediate device such as a remote control or a memory stick or a smart phone. Thus, one or all of the devices may act as storage, in particular for offline communication purposes.

In one example, the memory unit or network storage is of simple file type storage, i.e. one or multiple files are stored locally or on a network. The data may also be stored at a database such as a SQL database. The network storage may be located within a local network, for example a network of a clinic or a hearing device service center, but may also be placed somewhere on the web.

In a further embodiment of the fitting system according to the invention, the data interface comprises means for securing the data to be transferred. This includes different types of security means such as means for privacy protection, ensuring data integrity, authentication, authorization or accessibility. In one example, the data is secured by encrypting the data, for example by SSL (secure socket layer).

In a further embodiment of the fitting system according to the invention, the first fitting software module comprises security means for establishing entitlement to perform the fitting of the implantable device, in particular the fitting of the cochlear implant.

Further, the invention involves a method for fitting a bimodal hearing system by using a fitting system that comprises an initial fitting software module. The method comprises the steps of:
operationally connecting the implantable device to the fitting system;
providing hearing instrument related data to the initial fitting software module; and
fitting the implantable device by using the initial fitting software module, which thereby considers the provided data.

Further, the invention involves a method for fitting a bimodal hearing system by using a fitting system that comprises an initial fitting software module. The method comprises the steps of:
operationally connecting the implantable device to the fitting system;
providing hearing instrument related data to the initial fitting software module;
fitting the implantable device by using the initial fitting software module, which thereby considers the provided data; and
providing CI related data to a further fitting module.

In one example, the implantable part of the implantable device does not contain persistent data. The ‘fitting’ as such is stored in the not implanted part of the implantable device, e.g. in the speech processor (BTE or body worn).

In a further embodiment of the method according to the invention, the fitting system comprises a further fitting software module being connected to the initial fitting software module via a data interface and the step of providing of the data related to the hearing instrument comprises the steps of:
operationally connecting the hearing instrument to the fitting system;
fitting the hearing instrument by using the further fitting software module; and
transferring data related to the hearing instrument from the further fitting software module to the initial fitting software module via the data interface.

In a further embodiment of the method according to the invention, the fitting system comprises a further fitting software module being connected to the initial fitting software module via a data interface and the step of providing of the data related to the hearing instrument comprises the steps of:
operationally connecting the hearing instrument to the fitting system;
providing implantable device related data from the initial fitting module;
fitting the hearing instrument by using the further fitting software module, thereby considering the provided data; and
transferring data related to the hearing instrument from the further fitting software module to the initial fitting software module via the data interface.

Further, the invention involves a method for fitting a bimodal hearing system by using a fitting system comprising an initial fitting software module and a further fitting software module being connected to the initial fitting software module via a data interface. The method comprises the steps of:
operationally connecting a hearing instrument and an implantable device to the initial fitting system;
fitting the implantable device by using the initial fitting software module;
transferring data related to the implantable device from the initial fitting software module to the further fitting software module via the data interface; and
fitting the hearing instrument by using the further fitting software module, which thereby considers the provided data.

In a further embodiment of the method according to the invention, the data interface uses a direct, in particular a wireless, data connection established between the hearing instrument and the implantable device or an intermediate device, in particular a remote control or smart phone.

In a further embodiment of the method according to the invention, the providing of data comprises the step of providing configuration data, in particular at least one of:
data related to a hearing program, in particular at least one of a number, a type, a toggle order and a toggle sequence,
data related to an input source per hearing program,
audiological data, in particular at least one of a hearing loss and/or a gain prescription therefore,
information for synchronizing user actions, in particular a volume setting or a hearing program change,
data indicating a consequence, in particular at least one of a technical consequence and a perceptual consequence,
user specific data, in particular at least one of a name, an address and a phone number,
audiological data, in particular at least one of an audiological bandwidth, a cutoff frequency and an overlap of audio bandwidth between the hearing instrument and the implantable device, and
data related to a group delay alignment between the hearing instrument and the implantable device.

Thus, with this configuration data an effective, reliable and convenient fitting of the implantable device can be achieved.

The hearing program, also called a set of signal processing parameters, controls the signal processing of the hearing system or its components in dependence to a specific acoustic situation, for example in a noisy environment or in a situation related to a telephone call. The hearing program may be chosen manually by the user or automatically by the hearing instrument and/or the implantable device.

Further embodiments of the method according to the invention and their advantages correspond to the embodiments and advantages of the previously mentioned fitting system according to the invention.

Further, the invention involves a bimodal hearing system that comprises a hearing instrument and an implantable device that is operationally connectable to a fitting system according to any one of the previous device embodiments. Thereby the bimodal hearing system comprises a direct, in particular wireless, data connection between the hearing instrument and the implantable device for being used as part of the data interface. This way an efficient use of existing communication resources such as transmitter and/or receiver can be achieved.

In a further example, the implantable device and/or the hearing instrument comprises a communication unit for providing a, in particular wireless, data connection for the data to be transferred by the data interface.

Further, the invention involves a bimodal hearing system comprising a hearing instrument and an implantable device being operationally connected to the hearing instrument. Thereby the bimodal hearing system is configured to coordinate the operational behavior between the implantable device and the hearing instrument, in particular to coordinate the use of at least one component of the bimodal hearing system, further in particular to coordinate the selection of an input source. This way efficient use of available resources can be achieved, for example a coordinated and/or common use of a microphone, a wirelessly connected audio stream or a T-coil.

In an example, the hearing instrument comprises a housing, an input transducer such as a microphone, a processing unit and an output transducer such as a loudspeaker. The transducers convert an acoustical signal to an, in particular analog or digital, electrical signal or vice versa and may be based on electromagnetic, electrodynamic, electrostatic, piezoelectric or piezoresistive technology. The input transducer may also be a remote device, for example a remote microphone or a stationary or mobile telephone, which receives and converts an acoustical input signal remotely and transmits the converted signal to the processing unit of the hearing device via a wireless connection.

In another example, the implantable device comprises an output transducer that converts the intermediate signal into an electrical signal and/or a mechanical signal such as mechanical vibrations. In a further example, the output transducer is configured to apply the mechanical signal directly to the hearing bone of the user or to convert the electrical signal into a further electrical signal that is applied directly to the acoustic organ of the user, e.g. to the cochlea.

In particular, the invention proposes a hearing system that comprises several constituents, which are operationally connectable and which may be located at different places. Typically, said constituents are meant to be worn or carried by the user. For example, the constituents of the hearing system can be constituents for the left or the right ear of the user, a remote control, a remote input transducer or a remote output transducer.

It is expressly pointed out that any combination of the above-mentioned embodiments, or combinations of combinations, is subject to a further combination. Only those combinations are excluded that would result in a contradiction.

### BRIEF DESCRIPTION OF THE DRAWINGS

Below, the present invention is described in more detail by means of exemplary embodiments and the included drawings. It is shown in:

FIG. 1 a simplified block diagram illustrating an embodiment of a fitting system according to the invention comprising a data interface with network storage;

FIG. 2 a simplified block diagram according to FIG. 1, the data interface being a local software interface;

FIG. 3 a simplified block diagram according to FIG. 1, the data interface using the hearing instrument and the cochlear implant as communication relays; and

FIG. 4 a simplified block diagram according to FIG. 1, the data interface using a remote control or smart phone as communication relay.

### BRIEF DESCRIPTION OF THE INVENTION

The described embodiments are meant as illustrating examples and shall not confine the invention.

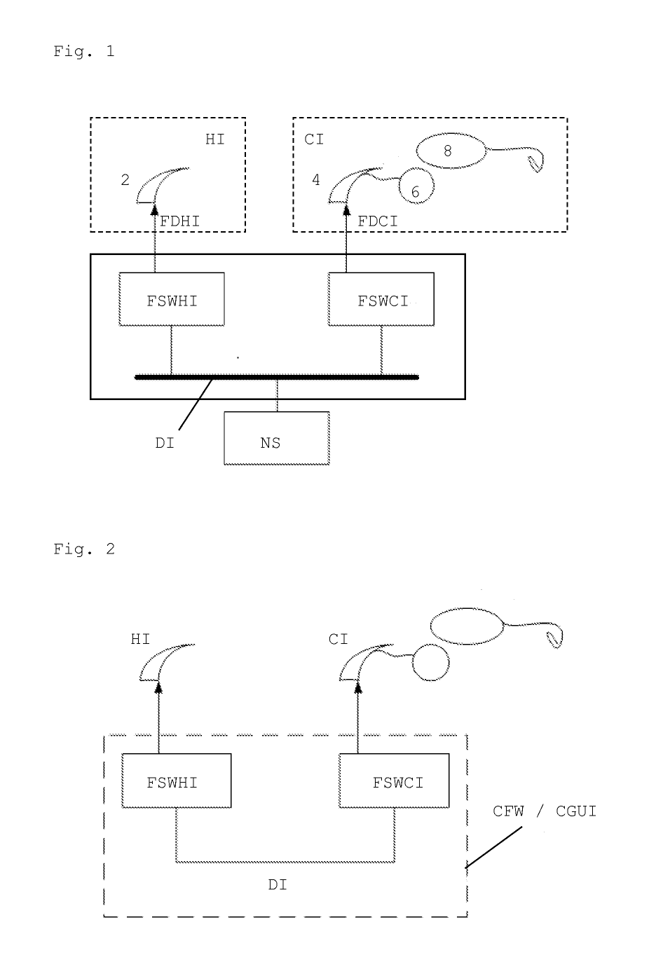

FIG. 1 shows a simplified block diagram illustrating an embodiment of a fitting system according to the invention. The fitting system (indicated by a solid line) comprises a first fitting software module FSWHI, a second fitting software module FSWCI and a data interface DI.

A hearing instrument HI and an implantable device, embodied by a cochlear implant CI (each indicated by a dashed line), are both operationally connected to the fitting system for transferring fitting data such as configuration data, in particular first fitting data FDHI is transferred from the first fitting software module FSWHI to the hearing instrument HI and second fitting data FDCI is transferred from the second fitting software module FSWCI to the cochlear implant CI. Further, the first fitting software module FSWHI and the second fitting software module FSWCI are operationally interconnected via the data interface DI. The terms “first” and “second” or “initial” and “further” do not imply a sequence or hierarchy of steps, they merely help to distinguish between the different fitting software modules and the different fitting data.

The term “operationally connected” is understood in the meaning that the operation of a second device being connected to a first device is depending on the operation of this first device, even with the presence of one or more interconnecting devices.

The hearing instrument HI comprises an earpiece 2 with a microphone (not shown) as input transducer, a signal processing unit (not shown) and a loudspeaker (not shown) as output transducer. The processing unit is operationally connected on its input side to the microphone for receiving an input signal, in particular an audio input signal. On its output side, the signal processing unit is operationally connected to the loudspeaker for forwarding an output signal to the loudspeaker of the earpiece 2.

The cochlear implant CI comprises a microphone (not shown), a speech processor 4, a headpiece 6 and an implant 8 (also called implanted part) with an electrode array. Similar to the above, the speech processor 4 is operationally connected on its input side to the microphone for receiving an input signal. However, on its output side, the speech processor 4 is operationally connected via a wireless connection to the implant 8 for forwarding the output signal to the electrode array of the implant 8.

The data interface DI is implemented by a data bus or data backbone to provide a bidirectional exchange of data. In this example, the data interface DI is a standardized interface, such that the first fitting software module being produced by a first vendor can exchange data with the second fitting software module being produced by a another vendor.

The exchanged data is related to the fitting of the bimodal hearing system, i.e. related to the fitting of the hearing instrument HI and the cochlear implant CI. In this example, the exchanged data is configuration data comprising:
the number, type and toggle order of the hearing programs, wherein each hearing program defines the operational behavior of the hearing instrument HI and the cochlear implant CI for a certain acoustic situation, and
data concerning the gain prescription of the hearing loss of the user.

As soon as this data has been transferred between the hearing instrument HI and the cochlear implant CI, each of the fitting software modules knows the fitting data of the peer device. Thus, the fitting of the cochlear implant CI is accomplished by considering of the fitting of the hearing instrument HI and vice versa. This mutual fitting produces a coordinated overall configuration of the bimodal hearing system. For example, a control command (e.g. initiated on a remote control) leads to coordinated behavior between the cochlear implant CI and the hearing instrument HI.

Further, a network storage NS is attached via a network connection to the data interface DI. In this example, the network storage is a database, which gives access to fitting related data via a local network located at the audiologist's office.

The data interface DI is configured to use this network storage, for intermittently storing the exchanged data. In this example both, the first fitting software module FSWHI and the second fitting software module FSWCI, are able to access the fitting related data in a shared manner. Thus, the network storage allows asynchronous data access over time and location.

FIG. 2 shows a simplified block diagram according to FIG. 1, wherein the data interface DI is a local software interface.

The first fitting software module FSWHI, the second fitting software module FSWCI and the local software interface are combined by using a common framework CFW and a common graphical user interface CGUI (indicated by a dashed line).

The local software interface is implemented by using a COM interface, in particular by a direct data transfer between the first fitting software module FSWHI and the second fitting software module FSWCI, both running concurrently on the same fitting system.

The combination of the first and second fitting software module FSWHI, FSWCI under a common graphical user interface CGUI provides for sharing of common tasks such as client data handling or report generation. Thus, although the first fitting software module FSWHI and the second fitting software module FSWCI are kept separate, the common graphical user interface CGUI graphically aligns the module appearance to the audiologist.

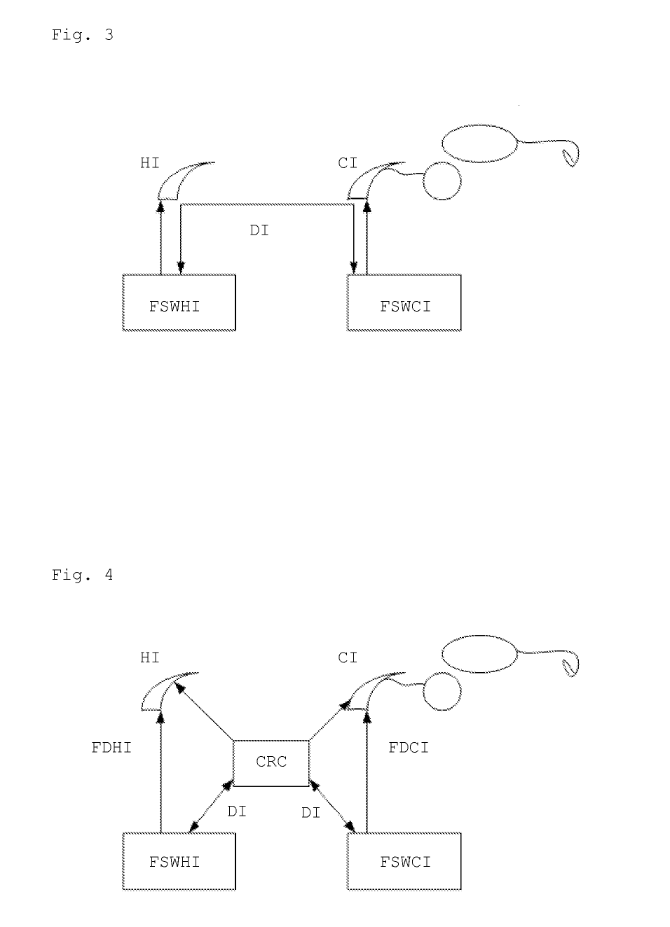

FIG. 3 shows a simplified block diagram according to FIG. 1, wherein the data interface DI uses an existing wireless data connection, which has been established to directly interconnect the hearing instrument HI and the cochlear implant CI. Thus, the data interface DI uses the hearing instrument HI and the cochlear implant CI as communication relays.

Further, the hearing instrument HI and/or the cochlear implant CI may also comprise a memory to provide a temporary storage for offline communication purposes or they may be configured to initiate a direct communication connection.

FIG. 4 shows a simplified block diagram according to FIG. 1, wherein the data interface DI uses a common remote control CRC or a smart phone as communication relay. The remote control controls the operational behavior of the hearing instrument HI and/or the cochlear implant CI.

In this example, the remote control RC is configured by the first fitting software module FSWHI and/or the second fitting software module FSWCI. Thus, the remote control RC or smart phone takes over the role of a communication relay and provides a bidirectional transfer of data between the first fitting software module FSWHI and the second fitting software module FSWCI and vice versa.

What is claimed is:

1. A fitting system for a bimodal hearing system, the fitting system being operationally connectable to a hearing instrument (HI) and to an implantable device (CI) and comprising a first fitting software module (FSWHI) for fitting the hearing instrument (HI), wherein the fitting system further comprises a second fitting software module (FSWCI) for fitting the implantable device (CI) by considering data of the hearing instrument (HI) received from the first fitting software module (FSWHI) via a data interface (DI) and/or vice versa.

2. The fitting system according to claim 1, wherein at least one of the first fitting software module (FSWHI) and the second fitting software module (FSWCI) is configured to at least one of transmit and receive the data as configuration data, in particular as fitting related data.

3. The fitting system according to claim 1, wherein the first fitting software module (FSWHI) and the second fitting software module (FSWCI) are configured for a mutual, in particular concurrent or common, coordination between the fitting of the implantable device (CI) and the fitting of the hearing instrument (HI).

4. The fitting system according to claim 1, wherein the fitting system comprises a third software module for providing a common framework (CFW) for the first fitting software module (FSWHI) and the second fitting software module (FSWCI).

5. The fitting system according to claim 1, wherein the fitting system comprises a fourth software module for providing a common graphical user interface (CGUI) for the first fitting software module (FSWHI) and the second fitting software module (FSWCI).

6. The fitting system according to claim 1, wherein the data interface (DI) is at least one of a standardized interface and an internal interface, in particular a COM or SOA interface.

7. The fitting system according to claim 1, wherein the data interface (DI) is configured to use a data connection, which directly, in particular wirelessly, connects the hearing instrument (HI) to the implantable device (CI) or to use an intermediate device (CRC), in particular a remote control or a smart phone.

8. The fitting system according to claim 1, wherein the data interface (DI) is connected to a memory unit, in particular a network storage unit, for, in particular intermittently, storing the data to be transferred.

9. The fitting system according to claim 1, wherein the data interface (DI) comprises means for securing the data to be transferred.

10. A method for fitting a bimodal hearing system by using a fitting system comprising an initial fitting software module (FSWCI), the method comprising the steps of:
operationally connecting the implantable device (CI) to the fitting system;
providing hearing instrument (HI) related data to the initial fitting software module (FSWCI); and
fitting the implantable device (CI) by using the initial fitting software module (FSWCI), which thereby considers the provided data.

11. The method according to claim 10, wherein the fitting system comprises a further fitting software module (FSWHI) being connected to the initial fitting software module (FSWCI) via a data interface (DI) and the step of providing of the data related to the hearing instrument (HI) comprises the steps of:
operationally connecting the hearing instrument (HI) to the fitting system;
fitting the hearing instrument (HI) by using the further fitting software module (FSWHI); and
transferring data related to the hearing instrument (HI) from the further fitting software module (FSWHI) to the initial fitting software module (FSWCI) via the data interface (DI).

12. A method for fitting a bimodal hearing system by using a fitting system comprising an initial fitting software module (FSWCI) and a further fitting software module (FSWHI) being connected to the initial fitting software module (FSWCI) via a data interface (DI), the method comprising the steps of:
operationally connecting a hearing instrument (HI) and an implantable device (CI) to the fitting system;
fitting the implantable device (CI) by using the initial fitting software module (FSWCI);
transferring data related to the implantable device (CI) from the initial fitting software module (FSWCI) to the further fitting software module (FSWHI) via the data interface (DI); and
fitting the hearing instrument (HI) by using the further fitting software module (FSWHI), which thereby considers the provided data.

13. The method according to claim 11, wherein the data interface (DI) uses a direct, in particular a wireless, data connection established between the hearing instrument (HI) and the implantable device (CI) or an intermediate device (CRC), in particular a remote control or smart phone.

14. The method according to claim 10, wherein the providing of data comprises the step of providing configuration data, in particular at least one of:
data related to a hearing program, in particular at least one of a number, a type, a toggle order and a toggle sequence,
data related to an input source per hearing program,
audiological data, in particular at least one of a hearing loss and/or a gain prescription therefore,
information for synchronizing user actions, in particular a volume setting or a hearing program change,
data indicating a consequence, in particular at least one of a technical consequence and a perceptual consequence,
user specific data, in particular at least one of a name, an address and a phone number,
audiological data, in particular at least one of an audiological bandwidth, a cutoff frequency and an overlap of audio bandwidth between the hearing instrument (HI) and the implantable device (CI), and
data related to a group delay alignment between the hearing instrument (HI) and the implantable device (CI).

15. A bimodal hearing system with a hearing instrument (HI) and an implantable device (CI) being operationally connected to the hearing instrument (HI), wherein the bimodal hearing system is configured to coordinate the operational behavior between the implantable device (CI) and the hearing instrument (HI), in particular to coordinate the use of at least one component of the bimodal hearing system, further in particular to coordinate the selection of an input source.
